(19) United States
(12) Patent Application Publication
(10) Pub. No.: US 2012/0192379 A1
(43) Pub. Date: Aug. 2, 2012

(54) BUSHING

(75) Inventors: Saro Vahe Amirian, Glendale, CA (US); Sevak Stepan Amirian, Glendale, CA (US); Hayghaz Amirian, Glendale, CA (US)

(73) Assignee: WINDGATE PRODUCTS CO., INC., San Fernando, CA (US)

(21) Appl. No.: 13/356,562

(22) Filed: Jan. 23, 2012

Related U.S. Application Data
(60) Provisional application No. 61/437,577, filed on Jan. 28, 2011.

(51) Int. Cl. F16C 33/04

(52) U.S. Cl. 16/2.5; 16/2.1

(57) ABSTRACT

A single, integral piece configured into a self-coupling bushing for pivotally securing within a circular opening of a structure without external fasteners, while accommodating a polygonal shaft. The bushing includes a base that is larger than the opening of the structure, and an aperture within the base. The aperture of the base of the bushing has a perimeter that includes first members for lining the opening of the structure, and pivotally securing the bushing within the opening, and second members for absorbing a rotational torque of the shaft, enabling the first members of the bushing to securely pivot within the opening of the structure.

### CROSS-REFERENCE TO RELATED APPLICATIONS

This application claims the benefit of priority of the co-pending U.S. Provisional Utility patent application No. 61/437,577, filed 28 Jan. 2011, the entire disclosure of which is expressly incorporated by reference herein.

### BACKGROUND OF THE INVENTION

1. Field of the Invention

This invention relates to a new bushing and, more particularly, to a single piece bushing for a sleeve (plenum, conduit, or duct) in accordance with the present invention.

2. Description of Related Art

Conventional bushings are well known and have been in use for a number of years. In general, most single piece bushings are normally comprised of nylon that are very much prone to failure due to their quick wear and tear (e.g., plastic or nylon bushings), very low tolerance to ambient variations (e.g., temperature, moisture, etc.) that can affect their overall performance, and easily crack or break if mishandled during installation.

Other bushings exist that may be comprised of ferrous materials such as iron, steel, etc. that may be forged to a desired shape. In general, most bushings made from ferrous materials that are forged to a desired shaped are comprised of multiple pieces rather than made of a single piece. Regrettably, bushings made of multiple pieces are more costly to manufacture and obviously require additional steps to assemble and install (which further adds to the overall cost due to labor and complications of installation and assembly). Also, given the use of multiple pieces to form a bushing, the potential for failure of each piece increases the overall potential of failure of the bushing.

It is important to note that, in order to replace a bushing that is used (for example) in Heating Ventilation and Air Conditioning (HVAC) system due to damage or failure, it is necessary to have physical access to the damaged bushing (or the component with which the bushing is coupled so to at least replace the entire component (if not the bushing alone)). For example, a failed bushing may have been installed and coupled on a plenum (sleeve, conduit, or duct), which, in turn, is installed inside of an already constructed structure such as a wall or ceiling. In other words, physical access to the broken-down bushing is something not always available and highly dependent upon details of the construction site. Further, in general, most plenum (sleeve, conduit, or duct) that use bushings also include insulating material that is normally placed around the plenum, completely covering the entire unit. Accordingly, very costly demolishing and then costlier complex re-construction of walls, ceilings, or other permanently build structures would be required for the replacement of a low cost bushing due to its failure. Therefore, replacement of a failed, low cost, small component such as a bushing would be costly in both parts production and required labor for replacement.

Accordingly, in light of the current state of the art and the drawbacks to current bushings mentioned above, a need exists for a low cost single piece bushing that would be mass producible, have sufficient malleability for stamping operation for low cost and high volume production, have high structural integrity (e.g., rigidity) for durability, and that would retain its form during and after installation (i.e., structural memory—preservation of the shape). Additionally, a need exists for a low cost single piece bushing that would have high level of tolerance to ambient (e.g., temperature, moisture, etc.) variations and galvanic corrosion.

### BRIEF SUMMARY OF THE INVENTION

A non-limiting, exemplary optional aspect of the present invention provides a bushing, comprising:

a single, integral piece configured into a self-coupling bushing for pivotally securing within a circular opening of a structure without external fasteners, while accommodating a polygonal shaft;

the bushing is comprised of:
a base that is larger than the opening;
an aperture within the base having a perimeter that includes:
first members for lining the opening, and pivotally securing the bushing within the opening; and
second members for absorbing a rotational torque of the shaft, enabling the first members of the bushing to securely pivot within the opening.

Another non-limiting, exemplary optional aspect of the present invention provides a bushing, wherein:

the perimeter of the aperture is configured substantially commensurate a transverse cross-sectional profile of the polygonal shaft, with first members aligned along vertices of the shaft, and second members along lateral sides of the shaft.

Still another non-limiting, exemplary optional aspect of the present invention provides a bushing, wherein:

the bushing is one of a snap bushing and a clip bushing.

Yet another non-limiting, exemplary optional aspect of the present invention provides a bushing, wherein:
the bushing is formed by stamping operation using a stamping press in which a punch and a die are used to modify one or more sheets or slit coil of ferrous or any metallic alloy material that is malleable, and includes blanking operation where one or more punched out pieces from the one or more sheets or slit coil of ferrous or any metallic alloy material that is malleable material constitute the formed bushing.

A further non-limiting, exemplary optional aspect of the present invention provides a bushing, wherein:

the first members are situated proximal a periphery edge of the base of the bushing, enabling the first members to line against the circular opening, and the second members are situated distal from the periphery edge of the base of the bushing, enabling the second members to absorb rotational torque of the shaft.

Still a further non-limiting, exemplary optional aspect of the present invention provides a bushing, wherein:

the first members protrude from a first side of the base.

Another non-limiting, exemplary optional aspect of the present invention provides a bushing, wherein:

the first side of the base is convex, and a second side of the base is concaved.

Still another non-limiting, exemplary optional aspect of the present invention provides a bushing, wherein:
the first members are flanges that protrude from a first side of the base of the device.

Yet another non-limiting, exemplary optional aspect of the present invention provides a bushing, wherein:
the first members are flanges that protrude from a first side of the base;
the flanges are single, continuous, integral pieces that are bent at an angle along an axial length of the flange, forming a first section, a bent section, and a second section;
a diagonal of vertices of the angle of the first section and the second section of the flanges having a span that is greater than a diagonal length of the opening, enabling the device to snap-fit within the opening;
the first section protrudes from the first side of the device, diverging at a first angle away from the aperture toward a periphery edge of the device; and
the second section commences at the bent, converging at a second angle toward the aperture, away from the periphery edge of the device.

A further non-limiting, exemplary optional aspect of the present invention provides a bushing, wherein:

second members are edges of the aperture.

Still a further non-limiting, exemplary optional aspect of the present invention provides a bushing, wherein:

second members are tabs that protrude from a first side of the base.

Yet a further non-limiting, exemplary optional aspect of the present invention provides a bushing, wherein:
the base is comprised of a first convex side that faces the structure, and a second concaved side, with an outer periphery edge of the bushing diverging away from the structure surface;
the curved base provides sufficient gap between the surface of the base and that of the structure to thereby facilitate rotation of the bushing, reducing contact surface area between the base and the structure, thereby lessening friction, which facilitates in rotation of the bushing;
the gap as a result of the curved base further provides sufficient space for the installation of a washer in between the structure and the bushing;
the curved base also facilitates in installation of the bushing onto the structure;
the diverging outer periphery edges of the curved base further enable coupling of a cap or cover onto the bushing second concaved side.

Another non-limiting, exemplary optional aspect of the present invention provides a bushing, further comprising:
a resilient element juxtaposed between the base and the body of structure to substantially impede and reduce flow of air;
the resilient element is comprised of a disc, having a hole that is configured appropriate with the perimeter of the aperture of the bushing, with an inner diameter of the hole smaller than the perimeter of the aperture of the bushing to allow for a tight fit of the resilient element onto the bushing;
the resilient element further has sufficient surface area to cover gaps between a flange and an adjacent tab, and gap between sides of the shaft and the perimeter of the aperture of the bushing;
the resilient element further included sufficient thickness to cover gap between a convex side of the base that faces the structure, with the periphery edges of the convex side of the base diverging away from the structure.

Still another non-limiting, exemplary optional aspect of the present invention provides a bushing, comprising:

a single, integral piece configured into a self-coupling bushing for accommodating a polygonal shaft;

the bushing is comprised of:
a base that is larger than the opening;
an aperture within the base having a perimeter that includes:
first and second members that protrude from a first side of the base and are asymmetrically positioned along the perimeter, with the first members set back further away from a center of the aperture near the periphery edge of the base.

Still a further non-limiting, exemplary optional aspect of the present invention provides a bushing The bushing as set forth in claim 14, wherein:

the first members are flanges;

the flanges are single, continuous, integral pieces that are bent at an angle along an axial length of the flange, forming a first section, a bent section, and a second section; a diagonal of vertices of the angle of the first section and the second section of the flanges having a span that is greater than a diagonal length of an opening with which the bushing is associated;
the first section protrudes from the first side of the device, diverging at a first angle away from the aperture toward a periphery edge of the device; and
the second section commences at the bent, converging at a second angle toward the aperture, away from the periphery edge of the device.

Another non-limiting, exemplary optional aspect of the present invention provides a bushing A bushing, comprising:

a single, integral piece configured into a self-coupling bushing for accommodating a polygonal shaft;

the bushing is comprised of:
first and second members that protrude from a first side of the base and are asymmetrically positioned along the perimeter, with the first members set back further away from a center of the aperture near a periphery edge of a base of the bushing.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIGS. 1A-1 to 1C-4 are non-limiting exemplary illustrations of the various views of a bushing associated with a shaft and a structure in accordance with the present invention;

FIGS. 2A to 2C are non-limiting exemplary top view illustrations of the bushing shown in FIGS. 1A-1 to 1C-4, but without the shaft or the structure in accordance with the present invention, and FIGS. 2D and 2E are non-limiting exemplary bottom view illustrations thereof; and

FIGS. 3A to 3D are non-limiting, exemplary illustrations of the bushing shown in FIGS. 1A-1 to 2E, including a washer in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The present invention provides a low cost single piece metallic (or alloys thereof) bushing that has sufficient malleability for being mass produced using stamping operation, and has a high structural integrity (e.g., rigidity) for durability, and retains its form or shape during and after installation. The present invention further provides a bushing that has sufficient structural memory to preserve its shape after installation, which may require bending to snap fit onto the structure. Additionally, the low cost single piece bushing of the present invention has a high level of tolerance to ambient variations (e.g., temperature, moisture, etc.) and galvanic corrosion. Non-limiting examples of material from which the single piece, mass-producible bushing of the present invention can comprise of are steel, copper, brass, tine, galvanized sheet metal, aluminum alloys, or any type of metal, metallic material or metallic alloys thereof. An exemplary bushing of the present invention enables a shaft with a polygonal profile to be pivotally secured with a body of a structure such as a sleeve (plenum, conduit, or duct), with the bushing frictionally cooperating with a lateral opening of the sleeve (plenum, conduit, or duct) body so to maintain the shaft at a desired pivot angle, while substantially sealing and reducing air leakage.

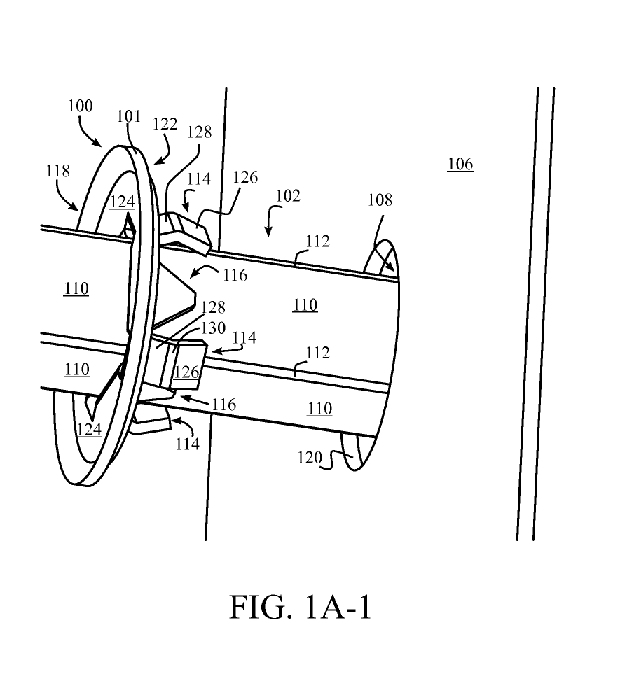

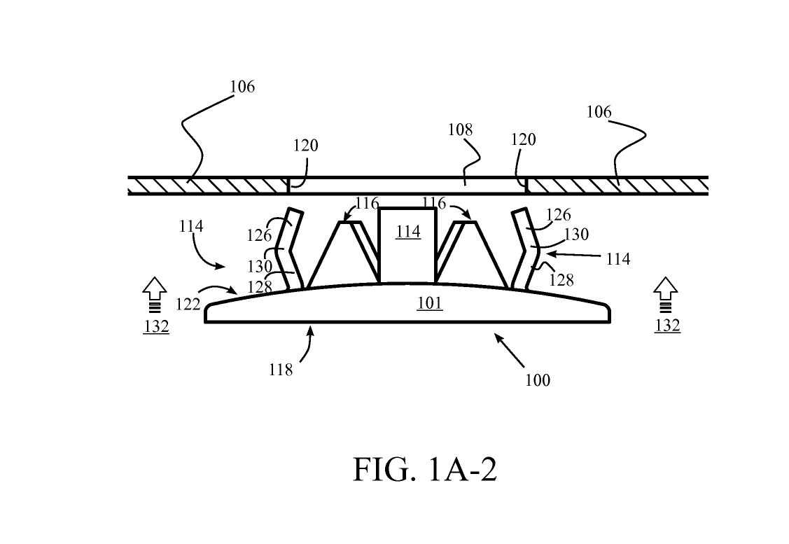

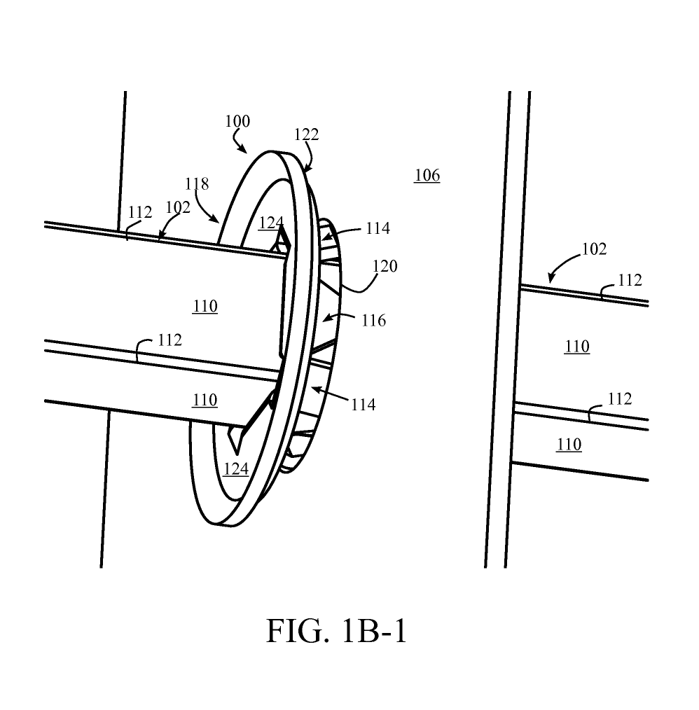

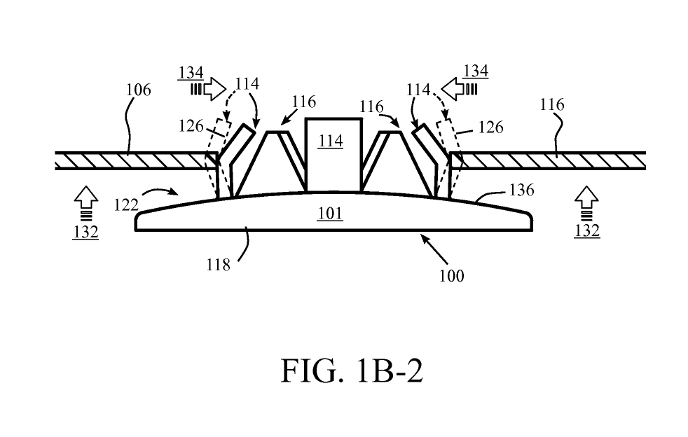

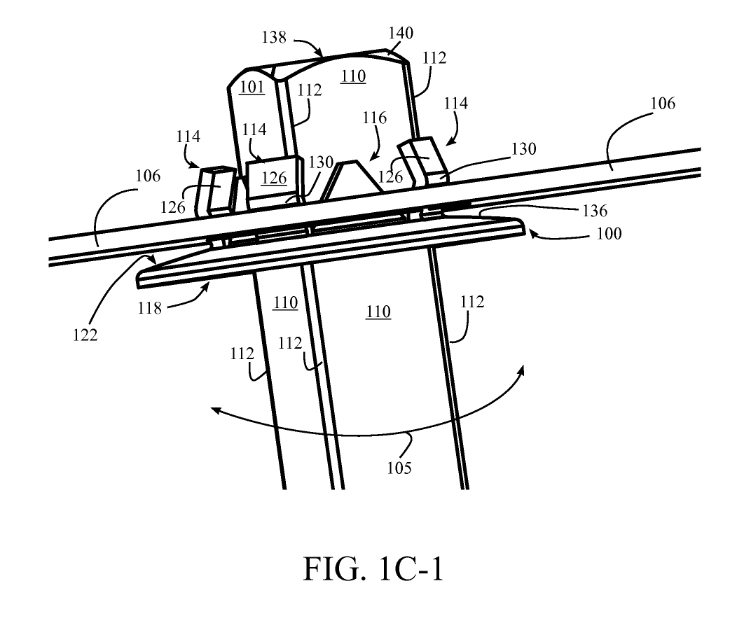

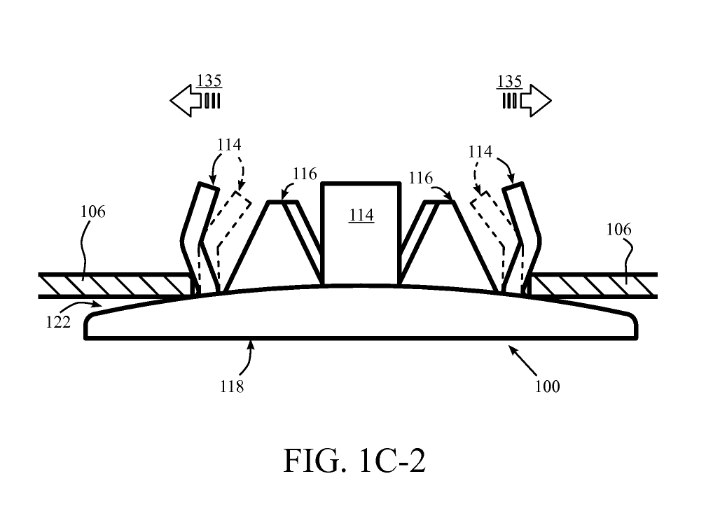

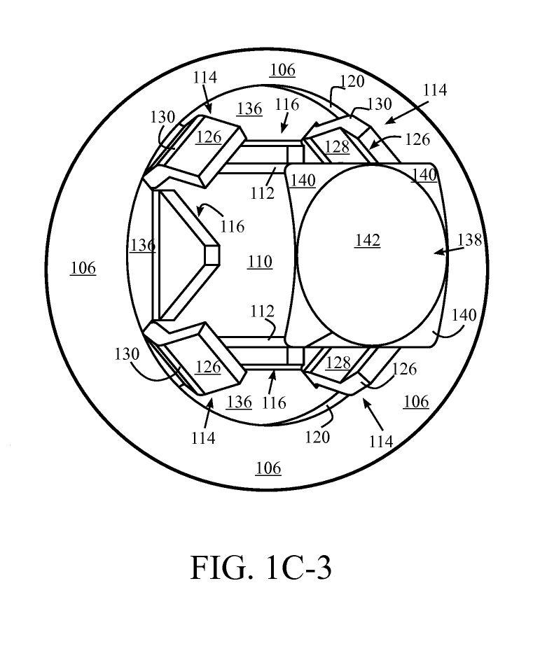

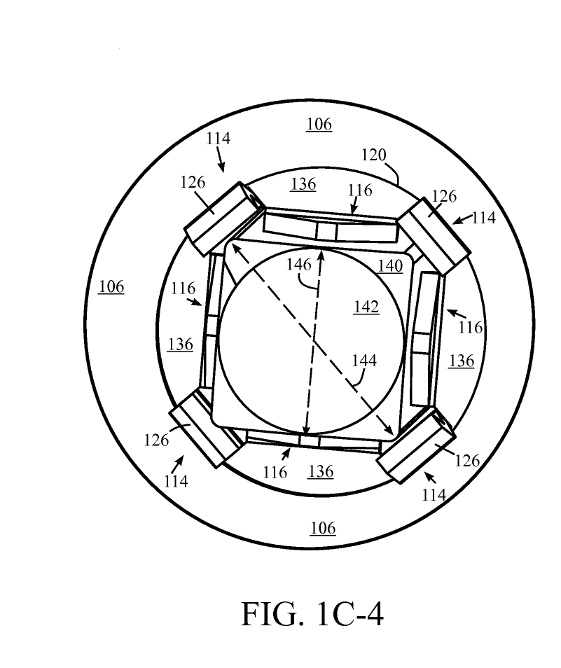

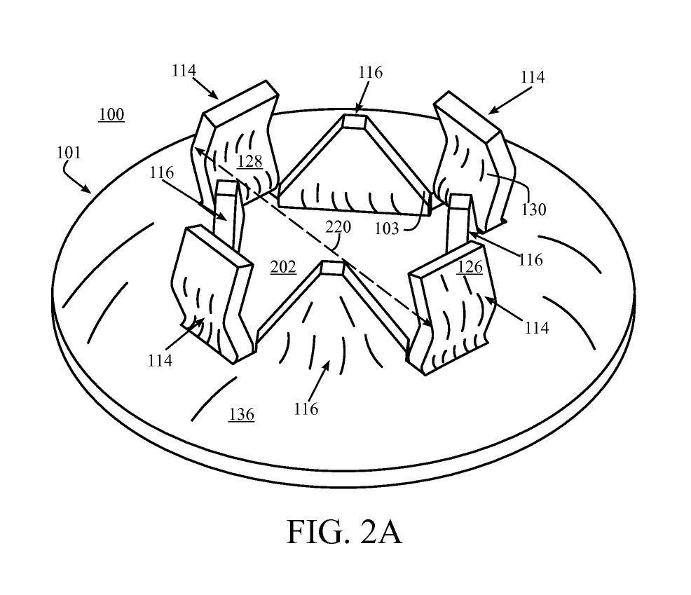

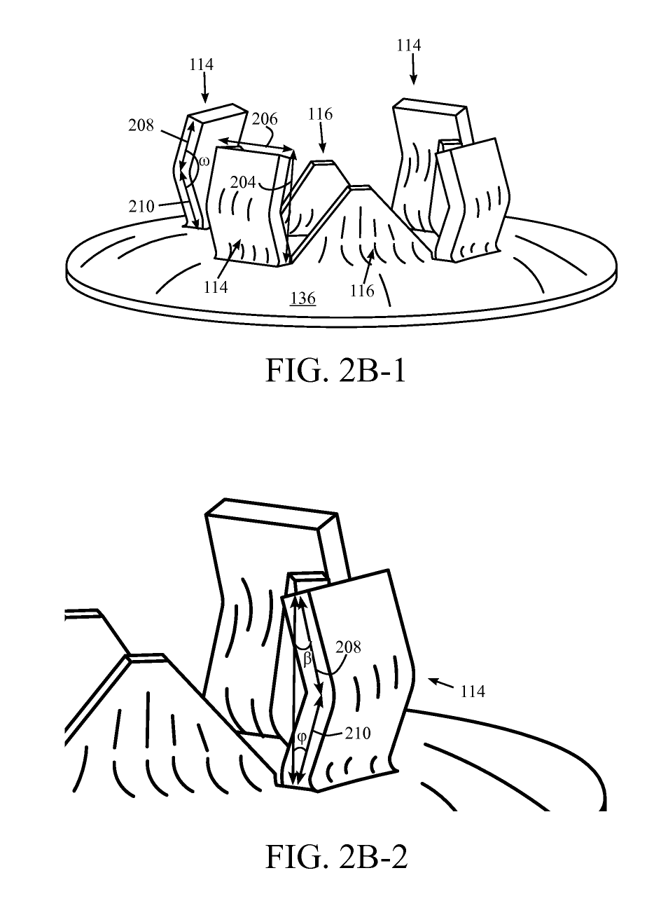

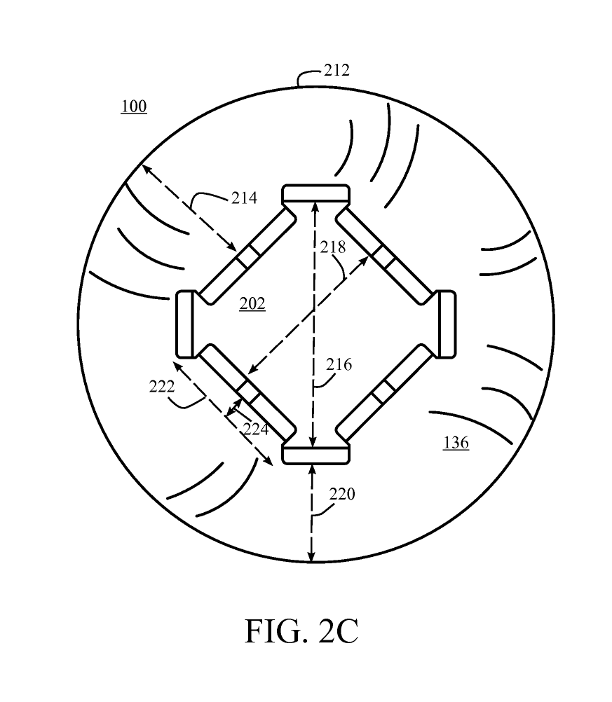

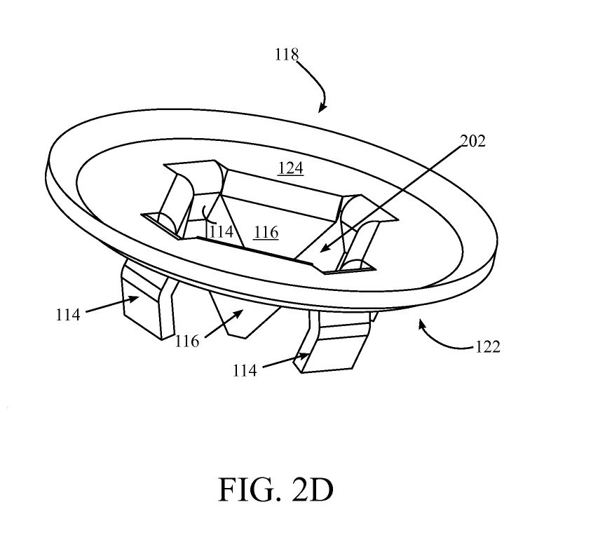

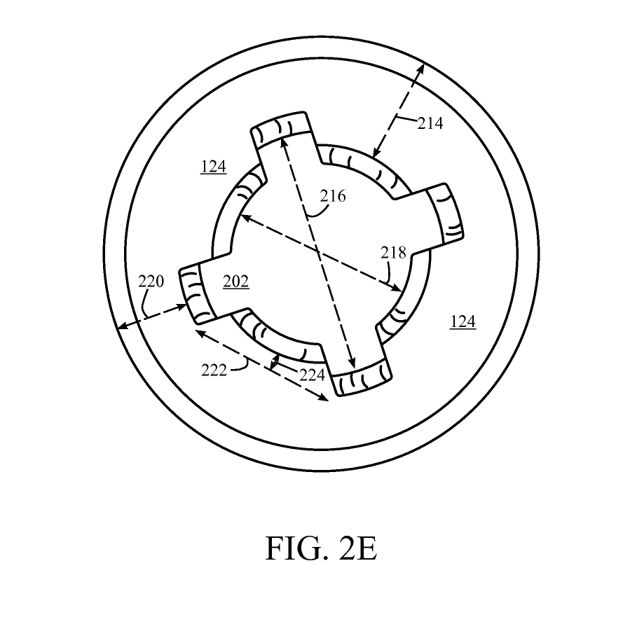

FIGS. 1A-1 to 1C-4 are non-limiting exemplary illustrations of the various views of a bushing associated with a shaft and a structure in accordance with the present invention. FIGS. 1A-1 to 1C-4 progressively illustrate the association, insertion and assembly of the bushing of the present invention with a shaft and a structure in various corresponding views from a non-inserted position (FIGS. 1A-1 to 1A-2) to a fully inserted and assembled position (FIGS. 1C-1 to 1C-4). Accordingly, FIGS. 1A-1 to 1A-2 are various views of the bushing 100 of the present invention associated with a shaft 102 prior to insertion and assembly with a structure 106 in accordance with the present invention. FIGS. 1B-1 and 1B-2 are various views of the bushing 100 of the present invention approximately about more than half way inserted into an opening of the structure. FIGS. 1C-1 to 1C-4 are various views of the fully assembled bushing 100 of the present invention with the structure.

In particular, FIGS. 1A-1, 1B-1, 1C-1, 1C-3, and 1C-4 are perspective views of the bushing 100 on the shaft in relation to the structure in accordance with the present invention. FIGS. 1A-1, 1B-1, 1C-1, 1C-3, and 1C-4 exemplarily illustrate from the perspective view the progressive insertion and full assembly of the bushing 100 with the shaft within the opening of the structure.

FIGS. 1A-2, 1B-2, 1C-2, are lateral (or profile) views of the busing 100 used to exemplary illustrate the progressive insertion of the bushing 100 from the lateral (or profile) views in the exact corresponding insertion positions shown in the perspective views of FIGS. 1A-1, 1B-1, 1C-1 to 1C-4 from a non-inserted position (FIG. 1A-2) to a fully assembled position (FIG. 1C-4).

As illustrated in FIGS. 1A-1 to 1C-4, the present invention is comprised of a bushing 100 that includes a single, integral piece comprised of ferrous material and configured into a self-coupling bushing 100 by stamping operation for pivotally securing within a circular opening 108 of a structure 106 without external fasteners, while accommodating a shaft 102 with a polygonal cross-section. As illustrated, the bushing of the present invention may comprise of a snap bushing or a clip bushing that snap or clip within the opening 108 of the structure 106.

The uses of ferrous or any metallic alloy material that is malleable are preferable because they are durable, commonly available (low cost), are strong, and are also sufficiently malleable to conform to a desired shape. That is, they are metals or alloys thereof able to be hammered or pressed permanently out of shape (e.g., using stamping operation) without breaking or cracking This property makes the bushing mass producible when manufactured using a stamping operation. The use of a single piece ferrous or any metallic alloy material that is malleable bushing that fixes itself without any external fasteners or multiple pieces provide the benefits of a single bushing (i.e., reduced number of parts) in addition to the durability of a ferrous material.

The bushing 100 of the present invention may, for example, be used in a damper mechanism (as the structure 106), comprising a damper blade (not shown) that is pivotally mounted and positioned within a longitudinal axial center opening of the damper mechanism by the shaft 102 that rotates along a reciprocating path 105 (FIG. 1C-1) that pivots the damper blade. The shaft 102 may be coupled with the damper mechanism by a first and second self-coupling bushings 100 (only one is shown). As stated above, the self-coupling bushing 100 is a single, integral piece comprised of ferrous material that is configured to pivotally secure within lateral circular openings (only one is shown) of the damper mechanism without external fasteners.

As further illustrated in FIGS. 1A-1 to 1C-4, the bushing 100 is comprised of a base 101 that is larger than the opening 108 of the structure 106 for securing the bushing onto the structure 106. The base 101 of the bushing 100 includes an aperture 202 (FIGS. 2A to 2E) having a perimeter 103 (FIG. 2A) that includes first members 114, a lower sections of which line the opening 108 of the structure 106, and pivotally secure the bushing 100 within the opening 108. Further included along the perimeter 103 are second members 116 for absorbing a rotational torque of the shaft 102, enabling the first members 114 of the bushing 100 to securely pivot within the opening 108 along the reciprocating pivot path 105. In general, the perimeter 103 of the aperture 202 is configured substantially commensurate a transverse cross-sectional profile 138 of the polygonal shaft 102, with first members 114 positioned along vertices 112 of the shaft 102, and second members 116 positioned along lateral sides 110 of the shaft 102.

As illustrated in FIGS. 1A-1 and 1A-2, in order to secure the bushing 100 with the structure 106, the busing 100 is aligned with a periphery 120 of the opening 108 of the structure 106. A first side (or top) 122 of the base 101 of the bushing 100 is oriented towards the opening 108 of the structure 106, with the first and second members 114 and 116 facing the opening 108. The shaft 102 may optionally be inserted through the aperture 202 of the bushing 100 and further inserted within the opening 108 of the structure 106 as illustrated in FIG. 1A-1, prior to securing the bushing 100 with the structure 106.

As illustrated in FIGS. 1B-1 and 1B-2, the bushing 100 is inserted into the opening 108 buy a push against the second side (bottom) 118 of the base 101 of the bushing 100 along the path 132. As illustrated, the first members 114 are configured to form “chamfered” sections (top portion of the first members 114) that enable ease of alignment and insertion of the bushing 100 into the opening 108 of the structure 106. As the bushing 100 is further pushed and further inserted into opening 108, the first members 114 are forced to move (along path indicated by arrows 134) and bent towards each other (towards the center of the busing 100) from their rest position (shown by the illustrated dashed line silhouette of the first members 114) to their indicated position (shown by the solid lines), with the body of the first members 114 pushing against the periphery 120 of the opening 108 of the structure 106 to squeeze in the bushing 100.

As illustrated in FIGS. 1C-1 to 1C-4, when fully inserted into the opening 108 of the structure 106, the first members 114 are moved or snapped back (along path indicated by arrows 135) and away from each other (away from the center of the busing 100) from their cramped or squeezed position (shown by the illustrated dashed line silhouette of the first members 114) back to their rest position (shown by the solid lines), with a lower section of the body of the first members 114 resting against the periphery 120 of the opening 108 of the structure 106. As best illustrated in FIGS. 1C-1 to 1C-4, once fully inserted, the bushing 100 of the present invention pivotally secures within the opening 108 of the structure 106 without requirements of any external fasteners, while accommodating the shaft 102 with its polygonal cross-section.

FIGS. 2A to 2C are non-limiting exemplary top view illustrations of the bushing shown in FIGS. 1A-1 to 1C-4, but without the shaft or the structure in accordance with the present invention, and FIGS. 2D and 2E are non-limiting exemplary bottom view illustrations thereof. As illustrated in all of the FIGS. 1A-1 to 2E, the bushing 100 is comprised of the base 101 that has the aperture 202 with the perimeter 103 that includes first members 114 for lining the opening 108 of the structure 106, and pivotally securing the bushing 100 within the opening 108 periphery 120. Further included along the perimeter 103 of the aperture 202 are the second members 116 for absorbing the rotational torque of the shaft 102, enabling the first members 114 of the bushing 114 to securely pivot within the opening 108 of the structure. In this non-limiting, exemplary instance, the axial length 204 of the first members 114 are approximately from 0.120 inches to 0.300 inches, and preferably a length of about 0.200 inches, with a width of about 0.120 inches to 0.200 inches, and preferably width of about 0.145 inches, with the bushing having a thickness of about 0.0187 inches to 0.0800 inches. Bushing may comprise of galvanized sheet metal, steel, stainless steel, any ferrous material, or any metallic material that is malleable, and has a preferred thickness of range of about 0.010 to 0.065 inches.

The bushing 100 is formed by the stamping operation using a stamping press in which a punch and a die are used to modify one or more sheets or slit coil of any metallic material and, and includes blanking operation where one or more punched out pieces from the one or more sheets or strips of metallic material constitute the formed bushing 100. The stamping operation is very well known, requiring male-female die-pair to stamp press the metallic material. The configuration of the base 101, an aperture 202, and the first and second members 114 and 116 of the bushing 100 are the result of the stamping operation, the die used, and the overall selected dimensions of the bushing 100.

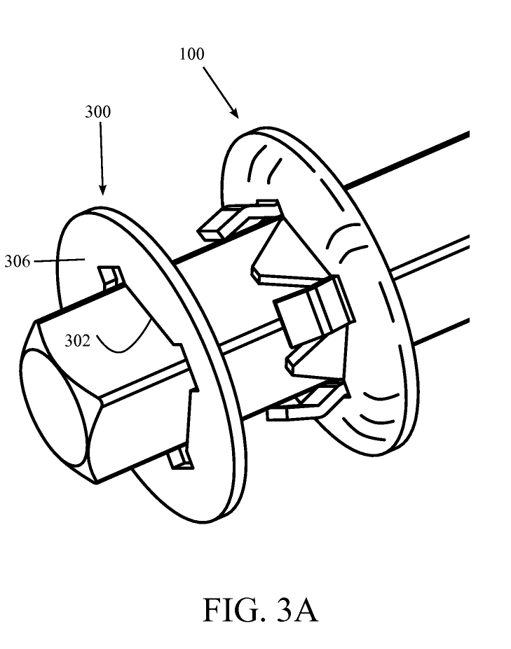

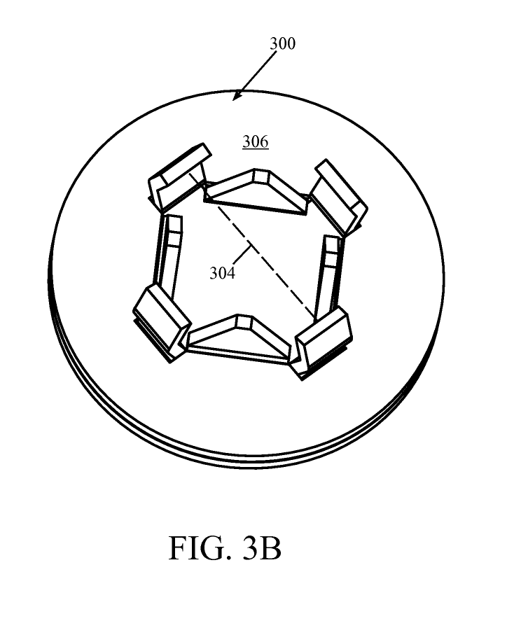

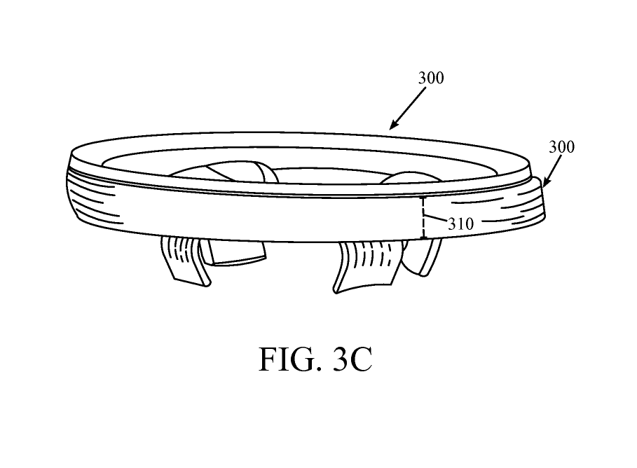

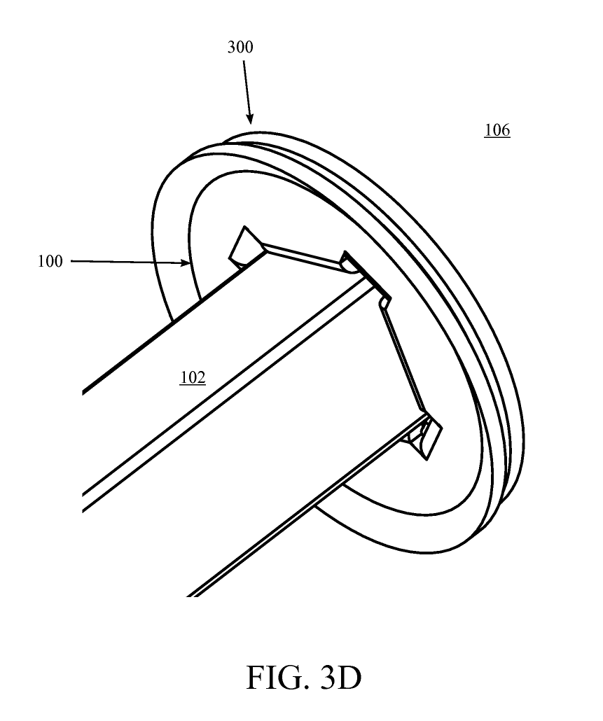

As best illustrated in FIGS. 1A-1 to 2E, the base 101 is comprised of a first convex side 122 that faces the structure 106, and a second concaved side 118, with an outer periphery edge 122 of the bushing 100 diverging away from the structure surface. The curved base 101 provides sufficient gap between the surface 136 of the first side 122 of the base 101 and that of the structure 106 to thereby facility rotation of the bushing 100. In other words, there is less surface area contact between the base 101 and the structure 106, thereby less friction, which facilitates in rotation of the bushing 100. The gap as a result of the curved base 101 further provides sufficient space for the installation of a washer 300 (illustrated in FIGS. 3A to 3D) in between the structure 106 and the bushing 100. The curved base 101 also facilitates in the overall installation of the bushing 100 onto the structure. The diverging outer periphery edge 122 of the curved base 101 further enables coupling of a cap or cover (not shown) onto the bushing second concaved side 118.

As best illustrated in FIGS. 2A to 2E, the first members 114 are flanges that protrude from the first (or top) side 122 of the base 101. The first side 122 of the base 101 is convex, and the second side 118 of the base 101 is concaved (FIGS. 2D and 2E). The first members 114 may comprise of any type of flanges (flat, straight, bent, or any configuration) that are extended or protrude from the convex side 122. The protrusion of the flanges 114 may be at any angle, including at a 90 degree angle in relation to the surface 136 of the first side 122 of the base 101. The flanges or first members 114 are single, continuous, integral pieces that are bent at an angle ω along their axial length 204 at an approximate, non-limiting, mid portion 130, forming a first section 128 with length 210 and a second section 126 with length 208. A diagonal 220 of vertices 130 of the angle to of the first section 128 and the second section 126 of the flanges 114 having a span that is greater than a diagonal length of the opening 108, enabling the bushing 100 to snap-fit within the opening 108.

As further illustrated in FIGS. 2B-1 and 2B-2, the first section 128 protrudes from the first side 122 of the bushing 100, diverging at a first angle φ (in relation to a vertical) away from the aperture 202 toward a periphery edge 212 of the bushing 100. The second section 126 commences at the bent 130, converging at a second angle β toward the aperture 202, away from the periphery edge 212 of the bushing 100. The second member 116 is as illustrated, which is a simple triangular tab. The second members 116 (as tabs) protrude from the first side 122 of the base 101 of the bushing 100.

The configuration of the base 101, aperture 202, including the position (or placement), and number of the first and second members 114 and 116 is intimately associated with the cross-sectional profile 138 of the shaft 102. In this exemplary instance, the shaft 102 has a substantially square cross-sectional profile 138, configured into an elongated rectangular-cube. Accordingly, the aperture 202 of the bushing 100 is substantially square, with four, first members 114 aligned along the lateral edges (corners, or vertices) 112 of the square-profile shaft 102, and four, second members 116 juxtaposed along lateral sides 110 of the square-profile shaft 102. As another example, with an exemplary shaft having a different cross-sectional profile, for example, a triangular cross-sectional profile, the aperture of the bushing 100 would be substantially triangular, with three, first members 114 aligned along the lateral edges (corners, or vertices) of the triangular-profile shaft, and three, second members juxtaposed along lateral sides of the triangular-profile shaft. Therefore, the bushing base 101, aperture 202 configuration, including the position and number of respective first and second members 114 and 116 of the bushing 100 may be commensurately varied to accommodate a shaft with any polygonal profile.

In addition, although the overall protruded rectangular configuration that constitutes the first members 114 is a result of the stamping operation that “punches” out the first members, the overall substantially “rectangular” configuration of the first members does not affect the overall operation of the bushing 100. Accordingly, the exemplary substantially rectangular shape of each first member may be varied according to the available material that is used to form the specifically sized bushing. In this exemplary instance, the length of the first members are approximately from about 0.205. As another example, the protruded triangular configuration that constitutes the second members 116 is a result of the stamping operation that “punches” out the second members 116, but the configuration or shape of the second members 116 does not affect the overall operation of the bushing 100. In other words, the second members 116 need not have a protruded (or raised) triangular configuration, and may simply be flat, straight periphery edges of the aperture 202 that abut against and are juxtaposed along the lateral sides 110 of the shaft 102 as the shaft 102 is inserted into the bushing aperture 202. The protruded (or raised) triangular configuration is simply a function of the stamping operation and the die used. That is, the function of absorbing rotational torque of the shaft 102 is not affected by the protruded (or raised) triangular configuration or the lack thereof; all that is minimally required is an edge that contacts and securely maintains the shaft 102 in place so to absorb rotational torque of the shaft 102 without excessive vibrations.

As further illustrated in FIGS. 2A to 2E, the position of the first members 114 are along the vertices 112 of the polygonal cross-sectional profile of the shaft 102, and the second members 116 are positioned along the lateral sides 110 thereof. The first members 114 are positioned across the diagonal 144 of the vertices 112 of the polygonal cross-sectional profile 138, which is a longer span than the side length 146 of the shaft 102 (FIG. 1C-4). Therefore, as best illustrated in FIG. 2C, the distance 216 between the first members 114 is longer than the distance 218 between the second members 116, which facilitate to accommodate the diagonal side 144 of the shaft 102. Further, the first members 114 have a longer span along their axial length 204 compared with the second members 116 to accommodate their bent 130. That is, the axial length 204 of the first members 114 must be of sufficient extent to accommodate the bent 130.

Given the selected overall small size of the bushing 100 and the amount of available material for the selected dimensions from which to form the bushing 100, the position of the first and second members 114 and 116 are not symmetrical in relation to one another, with the first members 114 set back further (by a distance 224) away from the center of the aperture 202 as compared with the second members 116. That is, given that there must be sufficient material within the selected dimensions of the bushing 100 to form the first members 114, the position and placement of the first members 114 are closer to the periphery edge 212 of the base 101 of the bushing 100 at a distance 220 as compared with the second members 16, which are away from the periphery edge 212 at a longer distance of 214. The fact that the first members 114 protrude from the surface 136 of the base 101 at the distance 220 closer to the periphery edge 212 of the bushing 100 (set back towards the periphery edge 212) provides for more surface or material from which to configure the first members 114. Placement or configuration of the first members 114 closer to the periphery edge 212 at the distance 220 allows the first members 114 to contact the periphery 120 the hole 108 of the structure 106, facilitating the first members 114 to line and abut against the periphery 120 of the opening 108 of the structure 106 (FIGS. 1C-3 and 1C-4).

The first members 114 are set at the diagonal to allow enough material for the snapping portion of the bushing 100 to occur. This increases the amount of material available (within the limited “real estate” or base 101 of the bushing 100) to create longer length first member flanges 114. As indicated, the first members 114 are positioned at the corners 112 of the shaft 102 because the diagonal potion (or the hypotenuse) of the square cross-sectional profile of the shaft 102 has greater span, requiring a greater amount of material to be stamped out, which translates into more available material (or surface area) to shape the first members 114 and also be bent at the mid-section for snap-fit and retention operation of the bushing 100. Additionally, the setting of the first members 114 at the corners 112 of the shaft 102 positions them closer to the opening periphery 120, requiring less bent (reduced angle) and use of less material to achieve the shape of the first members 114.

The first members 114 situated proximal 220 the periphery edge 212 of the base 101 of the bushing 100 enable the first members 114 to line against the circular opening 108, and the second members 116 situated distal 214 from the periphery edge 212 of the base 101 of the bushing 100, enabling the second members 116 to absorb rotational torque of the shaft 102. The flanges (first members) 114 positioned near periphery edge 212 of the base 101 enables them to be shorter than they would have been had they been further away, while being sufficiently long to facilitate for the bent mid-section without using extra material. If the first members were positioned further from the periphery edge 212, they would have to be bent 130 at a higher angle (smaller interior angle) to compensate for their distance away from the periphery edge 212. The flanges are positioned at the corners of the shaft because the diagonal portion 144 of the shaft 102 is longer, providing for a greater material from which to form the flange 114 by the stamping operation. The greater availability of material along the diagonal section 144 allows for sufficient length 204 of the flange 114 to also be bent 130. The flanges 114 at the corners 112 cause them to be closer to the circular opening 108 of the structures 106 for a tighter fit.

Therefore, the form or shape of each individual first and second member 114 and 116 is dictated by the size of the bushing 100 and is a result of the available material within the selected dimension that is used to form the first and second members 114 and 116, in addition to the entire bushing 100. Due to the stamping operation and the die used, material used to form the bushing 100 is stamped out from a radial center of the finally formed bushing 100, forming a small radial central opening or hole (prior to final product), which eventually becomes the aperture 202 of the bushing 100. Accordingly, it should be noted that this removal of material to form the small radial central opening or hole (prior to producing the final product) further removes additional material and reduces the overall available material for the formation of the remaining parts of the bushing 100, including the first and second members 114 and 116.

FIGS. 3A to 3D are non-limiting, exemplary illustrations of the bushing shown in FIGS. 1A-1 to 2E, including a washer in accordance with the present invention. As illustrated in FIGS. 3A to 3D, the bushing 100 further includes a resilient element (or washer) 300 juxtaposed between the base 101 and the body of structure 106 to substantially impede and reduce flow of air. The resilient element 300 is comprised of a disc, having a hole 302 that is configured appropriate with the perimeter of the aperture 202 of the bushing 100. The inner diameter 304 of the hole 302 is smaller than the perimeter 103 of the aperture 202 of the bushing 100, and so resilient member (or washer) 300 tightly fits onto the bushing 100. The resilient element 300 further has sufficient surface area 306 to cover gaps between a first member 114 and an adjacent second member 116, and gap between sides of the shaft 102 and the perimeter 103 of the aperture 202 of the bushing 100. The resilient element 300 further included sufficient thickness 310 to cover gap between a convex side of the base 101 that faces the structure 106, with the periphery edges 212 of the convex side of the base 101 diverging away from the structure 106. Although the resilient member 300 and the bushing 100 are illustrated as comprised of two separate pieces, co-injection-manufacturing processing may be used to form a single, integral piece bushing-washer combination.

Although the invention has been described in considerable detail in language specific to structural features and or method acts, it is to be understood that the invention described and shown in the drawings should not be limited to the specific features or acts described and shown. Rather, the specific features and acts (such as the measurements shown) are disclosed as exemplary preferred forms of implementing the invention. Stated otherwise, it is to be understood that the phraseology, terminology, and various measurements employed herein (and shown in drawings) are for the purpose of description and should not be regarded as limiting. Therefore, while exemplary illustrative embodiments of the invention have been described and shown, numerous variations and alternative embodiments will occur to those skilled in the art. For example, modifications, such as the removal or addition of structural flanges, having 3 flanges instead of 4 is contemplated. Other modifications such as altering the dimensions of the structural components, exemplary of this would be a shorting of one axial length and the lengthening of another. Also, stamping the bushing in its overall form as something other than round, such as a square or ellipse would serve an alternate example as well. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A bushing, comprising:
a single, integral piece configured into a self-coupling bushing for pivotally securing within a circular opening of a structure without external fasteners, while accommodating a polygonal shaft;
the bushing is comprised of:
a base that is larger than the opening;
an aperture within the base having a perimeter that includes:
first members for lining the opening, and pivotally securing the bushing within the opening; and
second members for absorbing a rotational torque of the shaft, enabling the first members of the bushing to securely pivot within the opening.

2. The bushing as set forth in claim 1, wherein:
the perimeter of the aperture is configured substantially commensurate a transverse cross-sectional profile of the polygonal shaft, with first members aligned along vertices of the shaft, and second members along lateral sides of the shaft.

3. The bushing as set forth in claim 1, wherein:
the bushing is one of a snap bushing and a clip bushing.

4. The bushing as set forth in claim 1, wherein:
the bushing is formed by stamping operation using a stamping press in which a punch and a die are used to modify one or more sheets of material, and includes blanking operation where one or more punched out pieces from the one or more sheets of material constitute the formed bushing.

5. The bushing as set forth in claim 1, wherein:
the first members are situated proximal a periphery edge of the base of the bushing, enabling the first members to line against the circular opening, and the second members are situated distal from the periphery edge of the base of the bushing, enabling the second members to absorb rotational torque of the shaft.

6. The bushing as set forth in claim 1, wherein:
the first members protrude from a first side of the base.

7. The bushing as set forth in claim 5, wherein:
the first side of the base is convex, and a second side of the base is concaved.

8. The bushing as set forth in claim 1, wherein:
the first members are flanges that protrude from a first side of the base of the device.

9. The bushing as set forth in claim 1, wherein:
the first members are flanges that protrude from a first side of the base;
the flanges are single, continuous, integral pieces that are bent at an angle along an axial length of the flange, forming a first section, a bent section, and a second section;
a diagonal of vertices of the angle of the first section and the second section of the flanges having a span that is greater than a diagonal length of the opening, enabling the device to snap-fit within the opening;
the first section protrudes from the first side of the device, diverging at a first angle away from the aperture toward a periphery edge of the device; and
the second section commences at the bent, converging at a second angle toward the aperture, away from the periphery edge of the device.

10. The bushing as set forth in claim 1, wherein:
second members are edges of the aperture.

11. The bushing as set forth in claim 1, wherein:
second members are tabs that protrude from a first side of the base.

12. The bushing as set forth in claim 1, wherein:
the base is comprised of a first convex side that faces the structure, and a second concaved side, with an outer periphery edge of the bushing diverging away from the structure surface;
the curved base provides sufficient gap between the surface of the base and that of the structure to thereby facilitate rotation of the bushing, reducing contact surface area between the base and the structure, thereby lessening friction, which facilitates in rotation of the bushing;
the gap as a result of the curved base further provides sufficient space for the installation of a washer in between the structure and the bushing;
the curved base also facilitates in installation of the bushing onto the structure;
the diverging outer periphery edges of the curved base further enable coupling of a cap or cover onto the bushing second concaved side.

13. The bushing as set forth in claim 1, further comprising:
a resilient element juxtaposed between the base and the body of structure to substantially impede and reduce flow of air;
the resilient element is comprised of a disc, having a hole that is configured appropriate with the perimeter of the aperture of the bushing, with an inner diameter of the hole smaller than the perimeter of the aperture of the bushing to allow for a tight fit of the resilient element onto the bushing;
the resilient element further has sufficient surface area to cover gaps between a flange and an adjacent tab, and gap between sides of the shaft and the perimeter of the aperture of the bushing;
the resilient element further included sufficient thickness to cover gap between a convex side of the base that faces the structure, with the periphery edges of the convex side of the base diverging away from the structure.

14. A bushing, comprising:
a single, integral piece configured into a self-coupling bushing for accommodating a polygonal shaft;
the bushing is comprised of:
a base that is larger than the opening;
an aperture within the base having a perimeter that includes:
first and second members that protrude from a first side of the base and are asymmetrically positioned along the perimeter, with the first members set back further away from a center of the aperture near the periphery edge of the base.

15. The bushing as set forth in claim 14, wherein:
the first members are flanges;
the flanges are single, continuous, integral pieces that are bent at an angle along an axial length of the flange, forming a first section, a bent section, and a second section; a diagonal of vertices of the angle of the first section and the second section of the flanges having a span that is greater than a diagonal length of an opening with which the bushing is associated;
the first section protrudes from the first side of the device, diverging at a first angle away from the aperture toward a periphery edge of the device; and
the second section commences at the bent, converging at a second angle toward the aperture, away from the periphery edge of the device.

16. A bushing, comprising:
a single, integral piece configured into a self-coupling bushing for accommodating a polygonal shaft;
the bushing is comprised of:
first and second members that protrude from a first side of the base and are asymmetrically positioned along the perimeter, with the first members set back further away from a center of the aperture near a periphery edge of a base of the bushing.
